(19) United States
(12) Patent Application Publication
(10) Pub. No.: US 2006/0131161 A1
(43) Pub. Date: Jun. 22, 2006

(54) Air sanitation with hydrogen peroxide

(76) Inventor: Gavin P. Towler, Barrington, IL (US)

Correspondence Address: JOHN G TOLOMEI, PATENT DEPARTMENT;UOP LLC, 25 EAST ALGONQUIN ROAD, P O BOX 5017, DES PLAINES, IL, 60017-5017, US

(21) Appl. No.: 11/313,468

(22) Filed: Dec. 21, 2005

Related U.S. Application Data
(62) Division of application No. 10/460,495, filed on Jun. 12, 2003.
Application No. 10/460,495 is a continuation-in-part of application No. 10/370,174, filed on Feb. 19, 2003.
Application No. 10/460,495 is a continuation-in-part of application No. 10/309,725, filed on Dec. 4, 2002.
Application No. 10/309,725 is a continuation-in-part of application No. 09/850,438, filed on May 7, 2001, now Pat. No. 6,713,036.

(51) Int. Cl. C01B 15/01

(52) U.S. Cl. 204/175

(57) ABSTRACT

An apparatus and process is disclosed for sanitizing air. The apparatus and process produce and use hydrogen peroxide to act upon pathogens in the air for the removal of the pathogens. In particular, the invention is for use in sanitizing recirculated air using water and power available at the site of the recirculated air, such as is found in an aircraft.

### CROSS-REFERENCE TO RELATED APPLICATION

This application is a Division of copending application Ser. No. 10/460,495, filed Jun. 12, 2003, which in turn is a Continuation-In-Part of copending application Ser. Nos. 10/370,174 filed Feb. 19, 2003 and 10/309,725 filed Dec. 4, 2002, all of which are incorporated by reference in their entirety. Application Ser. No. 10/309,725 filed Dec. 4, 2002 is a Continuation-In-Part of application Ser. No. 09/850,438 filed May 7, 2001, now U.S. Pat. No. 6,713,036, the contents of which are hereby incorporated by reference in their entirety.

### FIELD OF THE INVENTION

The present invention relates to a device and process for air sanitation using hydrogen peroxide.

### BACKGROUND OF THE INVENTION

Air conditioning in an aircraft is primarily limited to heating, cooling, humidification, dehumidification, and particulate removal, such as smoke. Numerous air conditioning systems have been developed, but the emphasis is on cooling and dehumidification of the air, as well as removal of particles from smoking, within an aircraft cabin.

Today, with the transportation of millions of people over long distances and within closed environments, the aircraft cabins need to be treated for pathogens put into the air by the normal breathing processes of the passengers. Therefore, the cabin air needs to be further treated to remove these pathogens.

Current air disinfection methods usually rely on generating chemicals such as ozone, as in U.S. Pat. No. 5,756,054, or the use of expensive equipment to generate high energy light, such as ultraviolet (UV) light to expose the air to the UV light.

There are many situations where the transport and use of chemicals are not convenient because of the detrimental effects on people, such as with ozone. It would be useful to sanitize the air in an aircraft during the recirculation to remove pathogens from the air, thereby reducing the spread of germs within the aircraft among the passengers.

There is a need for a convenient, relatively compact, and adaptable air sanitation system that does not require the transport and storage of large amounts of dangerous chemicals, or the production of dangerous chemicals.

### SUMMARY OF THE INVENTION

The present invention is an apparatus for the sanitation of air using hydrogen peroxide comprising an electrolyzer, a hydrogen peroxide reactor, and an air scrubber. The apparatus generates hydrogen peroxide from water and contacts the air with hydrogen peroxide solution to remove pathogens. This invention does not require the transport of added chemicals, but uses only water and electricity that are readily available in many environments.

The invention further comprises the process of sanitizing an air stream using hydrogen peroxide comprising the steps of electrolyzing water, generating a hydrogen peroxide solution from the decomposed water, and contacting the air stream with the hydrogen peroxide solution.

Other objects, advantages and applications of the present invention will become apparent to those skilled in the art after the following detailed description of the invention.

### BRIEF DESCRIPTION OF THE DRAWINGS

FIG. 1 is a diagram of the process of the present invention; and

FIG. 2 is a diagram of a gas-liquid contactor.

### DETAILED DESCRIPTION OF THE INVENTION

The need to disinfect air is more acute in today's environment. There are many air borne germs that can cause serious infections and illness. These germs can be removed by appropriate disinfecting, or sanitizing, means. The present invention provides for a disinfecting means without the need for expensive chemicals, especially in air that is recirculated. Hydrogen peroxide is a useful disinfectant, and can be used in many applications for that purpose. However, the storage and transport of hydrogen peroxide is inconvenient, especially if the need is for large quantities. The present invention provides for the manufacture of hydrogen peroxide on an as needed on-site basis, and only requires the availability of water and electrical power. This invention is useful for industrial buildings, homes, office buildings, and even for transportation systems where electrical power and water are readily available, such as on airplanes. The invention can be added to air conditioning systems where the air is processed through a central system.

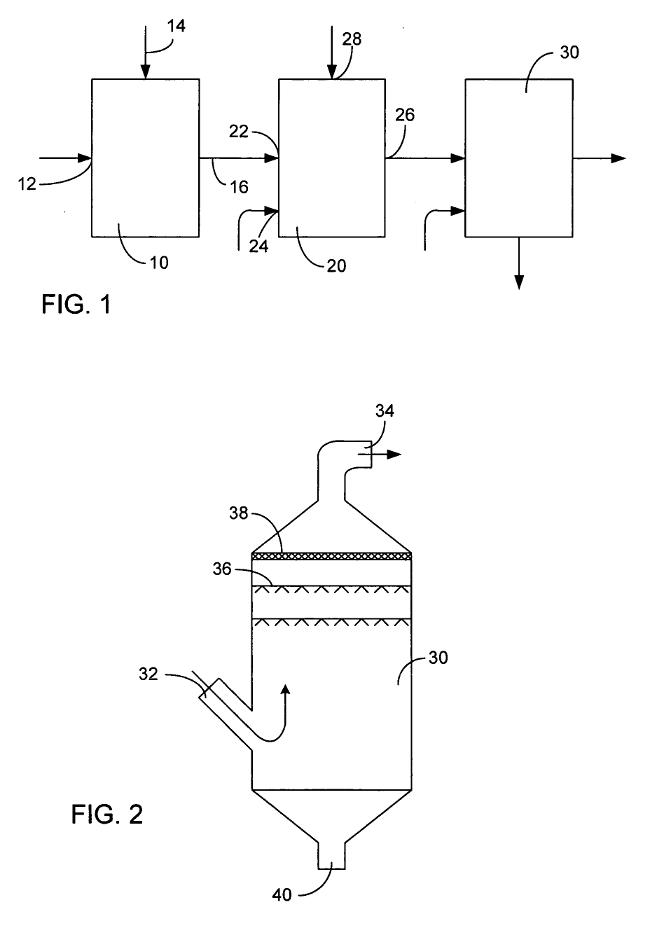

The present invention is an apparatus and process for disinfecting air through contacting the air with a mist of hydrogen peroxide to remove pathogens carried in the air. The apparatus, as diagramed in FIG. 1, comprises an electrolyzer 10 to separate water into its constituents of hydrogen and oxygen, generating a gas product. The gas may be separated into the separate constituents of hydrogen (H₂) and oxygen (O₂), or the gas may be a mixture of the hydrogen and oxygen. The electrolyzer 10 has an inlet for water 12, a source of power for electricity 14, and an outlet 16 for the gas product. The apparatus further comprises a hydrogen peroxide reactor 20. The reactor 20 has at least one inlet 22 for the electrolyzer product gas, an inlet 24 for water, and an outlet 26 for a hydrogen peroxide product. Optionally, the reactor 20 has an air inlet 28 for increasing the ratio of oxygen to hydrogen in the reactor 20.

The electrolyzer 10 comprises a plurality of electrodes separated by spacers. Water flows over the electrodes where it is decomposed into hydrogen and oxygen. The spacers provide channels for the water to flow along the length of the electrodes. Optimum operation of the electrolyzer 10 may be affected by contaminants in the water. Therefore, optional water treatments may be added to the apparatus, and include, but are not limited to, filters and deionization units.

The reactor 20 comprises a catalyst for reacting hydrogen and oxygen to form hydrogen peroxide. The catalyst comprises at least one catalytic metal component deposited on a support. The catalytic metal component is selected from platinum (Pt), palladium (Pd), ruthenium (Ru), rhodium (Rh), iridium (Ir), osmium (Os), and gold (Au). The support is a material selected from inorganic oxides, silica, alumina, titania, zirconia, carbon, silicon carbide, silica-alumina, diatomaceous earth, clay, and molecular sieves.

Optionally, the gas product from the electrolyzer 10 is delivered to the hydrogen peroxide reactor 20 as a gas bubble cloud in water. This provides for more rapid dissolution of the gas in the water, and the catalytic reaction of hydrogen and oxygen to hydrogen peroxide in the aqueous phase.

Optionally, the electrolyzer 10 and the hydrogen peroxide reactor 20 are combined into a single compact unit, wherein the electrolyzer generates hydrogen and oxygen in a flowing water solution forming a gas bubble cloud in the water. The water bearing the gas bubble cloud flows through the reactor 20 and over the catalyst contained therein forming a hydrogen peroxide solution. Further details on the electrolyzer and reactor are available in copending application Ser. Nos. 10/370,174 and 10/309,725 both of which are incorporated by reference in their entirety.

The hydrogen peroxide solution is directed to a chamber 30 for contacting the hydrogen peroxide with an air stream. Peroxygen sanitizers are well known and include compounds such as hydrogen peroxide. The contacting of a pathogen with hydrogen peroxide inactivates the pathogen. The contact inactivates the pathogen by either killing, eliminating, or reducing the capacity of the pathogen to infect a host.

A typical gas-liquid contacting, or air scrubbing, apparatus for contacting a gas with a liquid spray is shown in FIG. 2. The gas-liquid contactor will hereinafter be referred to as an air scrubber, or just a scrubber. The air scrubber comprises a chamber 30 having an air stream inlet 32, an air stream outlet 34, and at least one nozzle 36 for spraying a fine mist of hydrogen peroxide solution into an air stream. The scrubber is designed to spray a mist of droplets in the range from about 0.001 micrometers to about 100 micrometers, with the sprayer preferably designed to create droplets in the range from about 0.01 micrometers to about 10 micrometers. An even more preferred range of droplet size is from about 0.02 micrometers to about 5 micrometers. A distribution of small droplet sizes is desirable for improving the contact between the liquid and the air stream, and preferably the majority of the droplets will have a diameter of less than about 2 micrometers.

Air circulated in closed environments, such as office buildings or planes, is often filled with particulates from dust, smoke, etc. These particles may be carried in from external air drawn into the closed environment or from particles carried in on persons entering the environment. Optionally, prior to contacting the air with the hydrogen peroxide solution, the air is filtered to remove particulates. This can reduce the loading of filters in the gas-liquid contacting chamber.

An optional design for the scrubber includes a liquid dispersion means (channels, etc.) wherein the liquid is distributed over a screen. The air stream flows through the screen, contacting the liquid, and pathogens from the air are inactivated.

The design of gas-liquid contactors are well known in the art, and an appropriate design chosen will provide for good contacting and removal of at least 75% of the pathogens from the air stream. A particular design is subject to individual requirements for different environments, and can include multiple stages, or passing a portion of the air though secondary stages. For example, the requirements for a partially open environment will not be the same as for a closed environment. A house might have a certain desired level, but there is considerable interchange with the external air and subject to reasonable financial considerations, a moderate level of pathogen removal is chosen. A more closed environment, such as an aircraft, or an office building with windows that do not open will have a greater level of pathogen removal, such as maybe 90% removal, because of the recirculation of air within the aircraft or building. An even greater level of pathogen removal will be desired in a hospital environment, and even differing levels of pathogen removal within the hospital, such as a first level for the main portion of the hospital with a higher level of pathogen removal for operating rooms, and even higher levels for intensive care units. And further still, even higher levels of pathogen removal can be achieved for specialized environments, such as industrial clean rooms.

The scrubber further includes a liquid outlet 40 to the chamber 30 for removing any accumulated liquid. The accumulated liquid would comprise primarily water with materials scrubbed from the air stream. The liquid can be filtered and recycled, or optionally can be disposed of. A portion of the liquid can also be used for treating other surfaces in need of periodic sanitizing.

The spraying of an aqueous solution into the air stream creates a mist of liquid droplets. These droplets include hydrogen peroxide and subsequently need to be removed from the air stream, or inactivated before recycling the air into an environment with people. Removal of the droplets can be accomplished in a variety of ways. The choice of apparatus for removal can depend on a variety of factors, including, but not limited to, droplet sizes, temperature, pressure, speed of the air stream, etc. Methods of removal of droplets include filters having pores sized to remove droplets with diameters greater than about 0.1 micrometers. Other methods of droplet removal include, but are not limited to, impingement methods such as cyclones, mechanical precipitators, electrostatic precipitators, and the like. The droplets can also be removed through contacting the air stream with a water spray using a second gas-liquid scrubber.

Optionally, the droplets are inactivated before the conditioned air is cycled into a passenger cabin, or other room occupied by people. The hydrogen peroxide can be deactivated by passing the air stream carrying the droplets through a porous media comprising a decomposition catalyst. The catalyst comprises at least one catalytic metal component deposited on a support. The catalytic metal component is selected from V, Fe, Co, Ru, Cu, Ni, Mn, Mo, Pt, Au, Ag, Pd, Rh, Re, Os, and Ir. A preferred decomposition catalyst is MnO₂. The catalyst support material is any inert material on which the catalyst can be deposited, and includes but is not limited to, silica, alumina, titania, zirconia, carbon, silicon carbide, silica-alumina, diatomaceous earth, clay, and molecular sieves.

In an alternative, the air stream is bubbled through an aqueous solution of hydrogen peroxide. The hydrogen peroxide is generated as above, but as an alternative to spraying the hydrogen peroxide as a mist for contacting the air, the air passes through a sparger creating a bubble cloud, providing good contact between the air and hydrogen peroxide solution. The sparger preferably will generate bubbles having a diameter in the range from about 0.01 micrometers to about 10 micrometers.

This invention is intended to cover a broad spectrum of gas-liquid contacting systems when used in conjunction with a hydrogen peroxide generating system for the removal of pathogens from air. Gas-liquid contacting systems are known in the art, and there is considerable variation for design accounting for factors such as, but not limited to, the ratio of masses of gas to liquid, operating temperature and pressure conditions, and mass transfer considerations to achieve a desired removal of pathogens.

This invention is also applicable for use with air conditioning units. Air conditioning units used for cooling in homes and buildings create cool, damp environments where the air is cooled and moisture condensed from the air. This is an ideal environment for mold and/or mildew. The periodic generation of a hydrogen peroxide solution to treat the cooling surfaces of an air conditioning unit and especially surfaces where moisture is collected can prevent the growth of mold and/or mildew. In addition to air conditioning units, this is applicable to other surfaces that are susceptible to the growth of mold and/or mildew.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A process for the sanitization of an air stream comprising the steps of:
electrolyzing water in an electrolyzer to generate hydrogen and oxygen;
passing the hydrogen and oxygen to a reactor where the hydrogen and oxygen are reacted at reaction conditions to generate a hydrogen peroxide solution; and
contacting the air stream with the hydrogen peroxide solution to produce a sanitized air stream.

2. The process of claim 1 wherein the reactor comprises a catalyst, the catalyst comprising at least one catalytic metal component deposited on a support, wherein the catalytic metal component is selected from the group consisting of platinum (Pt), palladium (Pd), ruthenium (Ru), rhodium (Rh), iridium (Ir), osmium (Os), gold (An), and mixtures thereof.

3. The process of claim 2 wherein the support comprises a material selected from the group consisting of silica, alumina, titania, zirconia, carbon, silicon carbide, silica alumina, diatomaceous earth, clay, molecular sieves, and mixtures thereof.

4. The process of claim 1 further comprising the step of filtering the air stream before contacting with the hydrogen peroxide.

5. The process of claim 1 wherein the contacting step comprises spraying a fine mist of hydrogen peroxide droplets in a chamber through which the air stream flows.

6. The process of claim 5 wherein the hydrogen peroxide droplets have a diameter in the range from about 0.001 micrometers to about 100 micrometers.

7. The process of claim 6 wherein the hydrogen peroxide droplets have a diameter in the range from about 0.01 micrometers to about 10 micrometers.

8. The process of claim 1 further comprising the step of separating the sanitized air stream from the hydrogen peroxide solution.

9. The process of claim 8 wherein the separating step comprises using an apparatus selected from the group consisting of a cyclone, an impingement precipitator, an electrostatic precipitator, a filter, or combination thereof.

10. The process of claim 1 further comprising the step of scrubbing the sanitized air stream with water.

11. The process of claim 1 further comprising the step of passing the sanitized air stream over a decomposition catalyst to decompose the remaining hydrogen peroxide.

12. The process of claim 11, wherein the decomposition catalyst comprises at least one catalytic metal component deposited on a support, wherein the catalytic metal component is selected from the group consisting of V, Fe, Co, Ru, Cu, Ni, Mn, Mo, Pt, Au, Ag, Pd, Rh, Re, Os, Ir, and mixtures thereof.

13. The process of claim 1 wherein the contacting step comprises bubbling the air stream through a hydrogen peroxide solution.

14. The process of claim 13 wherein the contacting step comprises flowing the air through a sparger placed in the hydrogen peroxide solution to generate tiny air bubbles wherein the air bubbles have a diameter in the range from about 0.01 micrometers to about 10 micrometers.

15. A process for controlling mold and/or mildew comprising the steps of:
electrolyzing water in an electrolyzer to generate hydrogen and oxygen;
passing the hydrogen and oxygen to a reactor where the hydrogen and oxygen are reacted at reaction conditions to generate a hydrogen peroxide solution; and
contacting the hydrogen peroxide solution with surfaces containing mold and/or mildew thereby destroying at least a fraction of the mold and/or mildew.
